(19) United States
(12) Patent Application Publication
(10) Pub. No.: US 2013/0234843 A1
(43) Pub. Date: Sep. 12, 2013

(54) SCROLLING CONTROL SYSTEM HAVING TACTILE FEEDBACK

(71) Applicant: Daniel SHAKESPEAR, Lake Orion, MI (US)

(72) Inventor: Daniel SHAKESPEAR, Lake Orion, MI (US)

(73) Assignee: GM GLOBAL TECHNOLOGY OPERATIONS LLC, Detroit, MI (US)

(21) Appl. No.: 13/413,840

(22) Filed: Mar. 7, 2012

(51) Int. Cl. G08B 6/00

(52) U.S. Cl. 340/407.2

(57) ABSTRACT

A scrolling control system having tactile feedback includes a rotational control for scrolling through a plurality of user selections. Also included is a first position of the rotational control, wherein rotation away from the first position scrolls through the plurality of user selections. Further included is a pulsating system for providing tactile feedback to a user, wherein the pulsating system distributes pulses at a plurality of frequencies that correspond to a plurality of rotational control positions.

### FIELD OF THE INVENTION

The subject invention relates to scrolling controls, and more particularly to scrolling control systems having tactile feedback.

### BACKGROUND

Scrolling controls are employed to allow a user to freely scroll through selections associated with a user system. Typically, such controls fall into two categories.

First, the scrolling control may be of a continuous motion type, where a user rotates the control until a selection is reached. Often, the continuous motion type of scrolling control provides passive tactile feedback, such as one clicking sensation per selection step. Although feedback is provided, the user must continuously move the scrolling control to scroll to the desired selection. Such an arrangement requires extensive motion for the user, particularly when scrolling through a long list of selections. Second, the scrolling control may be of a push-and-hold type. Such an arrangement alleviates the need to continuously move the control, but requires continuous or substantial visual attention to the scrolling process, since tactile feedback is typically not provided. The requirement for visual attention may prove distracting when performing another activity, such as operating a vehicle, or may simply be undesirable.

### SUMMARY OF THE INVENTION

In one exemplary embodiment of the invention, a scrolling control system having tactile feedback includes a rotational control for scrolling through a plurality of user selections. Also included is a first position of the rotational control, wherein rotation away from the first position scrolls through the plurality of user selections. Further included is a pulsating system for providing tactile feedback to a user, wherein the pulsating system distributes pulses at a plurality of frequencies that correspond to a plurality of rotational control positions.

In another exemplary embodiment of the invention, a scrolling control system having tactile feedback includes a rotational control for scrolling through a plurality of user selections. Also included is a first position of the rotational control, wherein rotation away from the first position scrolls through the plurality of user selections. Further included is a second position of the rotational control that is disposed at a first angle from the first position, wherein a first scrolling frequency occurs when the rotational control is disposed at the second position. Yet further included is a third position of the rotational control that is disposed at a second angle that is greater than the first angle, wherein a second scrolling frequency occurs when the rotational control is disposed at the third position, and wherein the second scrolling frequency is greater than the first scrolling frequency. Also included is a pulsating system for providing tactile feedback to a user.

In yet another exemplary embodiment of the invention, a vehicle having a tactile feedback control system includes a user system including a rotational control for scrolling through a plurality of user selections. Also included is a first position of the rotational control, wherein rotation away from the first position scrolls through the plurality of user selections. Further included is a tactile response mechanism for providing a plurality of tactile feedback sensations corresponding to a plurality of rotational control positions.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a rotational control for scrolling through a plurality of user selections;

FIG. 2 illustrates a relationship between an angle of rotation of the rotational control and a tactile feedback sensation frequency according to one embodiment; and

FIG. 3 illustrates a relationship between an angle of rotation of the rotational control and a tactile feedback sensation frequency according to another embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

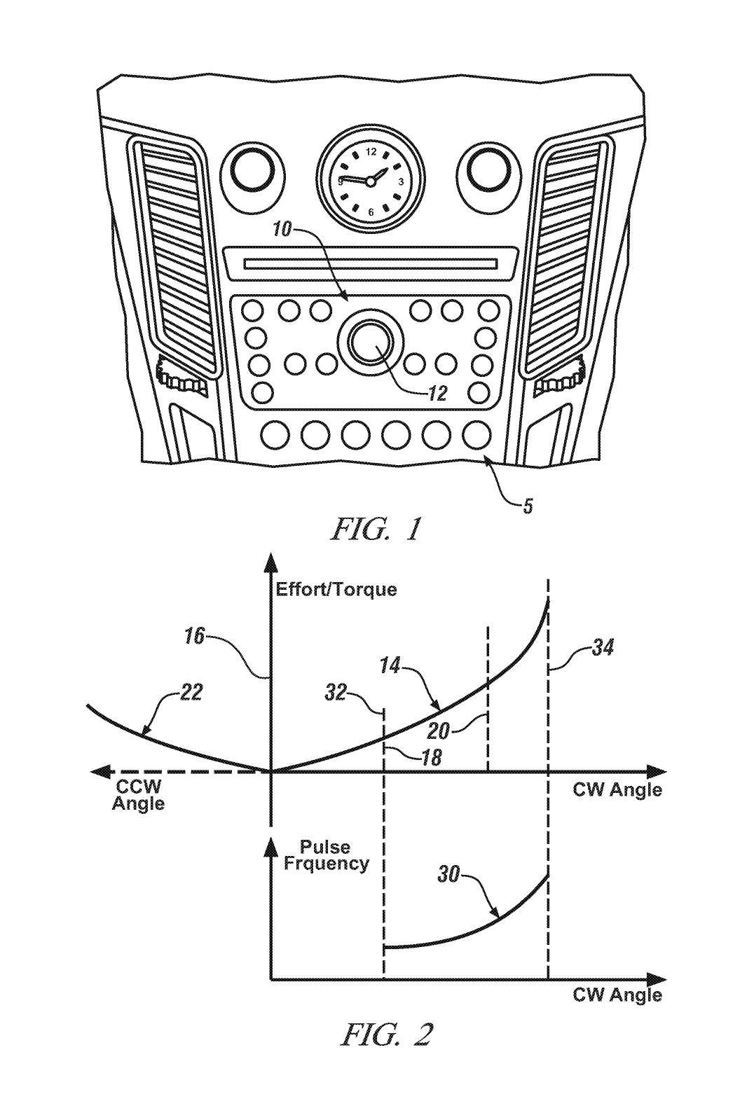

Referring to FIG. 1, in accordance with an exemplary embodiment of the invention, a scrolling control system having tactile feedback is illustrated generally with reference numeral 10. The scrolling control system 10 is illustrated within the interior of a vehicle 5, and more particularly an automobile, however it is to be appreciated that the scrolling control system 10 may be employed for use in conjunction with numerous other applications. For example, rather than an automobile, the type of vehicle that the scrolling control system 10 is disposed within may include, but is not limited to, a boat, ship or aircraft. Additionally, the scrolling control system 10 may be used with any system that requires a user to scroll through user options. The system may pertain to computers or associated computer components (e.g., mouse scrolling wheel), entertainment devices, or any other system that provides the ability to scroll through user options, such as a list.

The scrolling control system 10 includes a rotational control 12 that facilitates the ability for a user to scroll through a plurality of user selections that are associated with a user system. The user system may be associated with a number of systems. For the illustrated vehicle embodiment, the user system may comprise an audio system or a navigational system, for example. In the case of an audio system, the plurality of user selections may be radio stations, audio settings, or files on an audio accessory that is associated with the audio system. The files may include songs or recordings of various types. It is to be appreciated that the aforementioned examples of the user system and the plurality of user selections are merely illustrative and both the user system and the plurality of user selections may comprise any system that comprises a scrolling function, as previously stated.

The rotational control 12 is the component rotated by a user to scroll through the plurality of user selections. The rotational control 12 may be a rotary knob, a barrel roller, a switch, a scroll wheel or a 3D motion controller which provides the user the ability to rapidly scroll through lists. The scrolling control system 10 includes a tactile response mechanism that responds to rotation of the rotational control 12 and is configured to provide tactile feedback to the user during a scrolling function. The tactile feedback may be in the form of vibrational pulses that are generated at various frequencies, with each frequency corresponding to a rate of scrolling through the plurality of user selections. The user may controllably manipulate the rate of scrolling by rotating the rotational control 12 and this function will be explained in detail below.

Referring to FIG. 2, an angle-torque relationship 14 is illustrated. Specifically, the angle-torque relationship 14 depicts the relationship between the rotational position of the rotational control 12 and a torque associated with movement away from a first position 16. The first position 16 represents a neutral position of the rotational control 12 that is centered and gravitated toward, as well as a position that generates no scrolling. Increasing the torque, i.e. the angle away from the first position 16, correspondingly increases the rate of scrolling through the plurality of user selections. In the event that the user desires to scroll through the plurality of user selections, rotation in the clockwise direction, for example, begins the scrolling function and also initiates the tactile response mechanism that may comprise a pulsating system that generates the tactile feedback to the user. As the rotational control 12 is rotated away from the first position 16, an angle is defined between the first position 16 and the rotated-to position. The angle determines the scrolling rate and the frequency of vibrational pulses felt by the user. By way of example, a second position 18 of the rotational control 12 is disposed at a first angle from the first position 16 and generates a first scrolling frequency. Additionally, a third position 20 of the rotational control 12 is disposed at a second angle from the first position 16, where the second angle is greater than the first angle. Positioning of the rotational control 12 in the third position 20 generates a second scrolling frequency that is greater than the first frequency, based on the fact that the rotational control 12 is rotated further than when disposed in the second position 18.

It can be seen from the angle-torque relationship 14 that the torque, and therefore the scrolling frequency, may increase exponentially based on rotation of the rotational control 12. It is to be appreciated that the illustrated angle-torque relationship 14 is merely exemplary, and it is conceivable that numerous distinct relationship profiles may be employed by simply modifying the tactile feedback mechanism, which comprises, at least in part, at least one actuator that responds to an electrical stimulus. Only a partial angle-torque relationship 22 for rotation of the rotational control 12 in the counterclockwise direction is illustrated, however, it is to be understood that the scrolling control system 10 may employ a mirror-image function of the clockwise rotational function, as described above.

In operation, as the rotational control 12 is rotated, the tactile feedback in the form of vibrational pulses is initiated at a relatively slow frequency and the frequency is increased as the rotational control is rotated away from the first position 16, which is the position in which the rotational control 12 is self-centered about, similar to an at rest position of a spring. The increase in frequency is illustrated generally as pulse frequencies 30, where each pulse is shown relative to time. The pulses are added to the self-centering (static) torque associated with movement of the rotational control 12 away from the first position 16. It is to be appreciated that the pulses occur at a frequency related to the angle that the rotational control 12 is disposed at. Therefore, a user is provided the ability to hold the rotational control 12 at a certain location during scrolling while the pulses continue to provide tactile feedback with respect to the rate of scrolling.

The initiation of the vibrational pulses may be delayed until the rotational control 12 has reached a predetermined rotational angle 32 with respect to the first position 16. Such an embodiment is illustrated and the corresponding vibrational pulses are initiated at the predetermined rotational angle 32. The scrolling control system 10 may also include a maximum angle 34 that the rotational control 12 may rotate to. Such a maximum angle 34 is typically set to a comfortable location for a user's wrist. It is at the maximum angle 34 that the user is able to achieve a maximum scrolling function through the plurality of user selections.

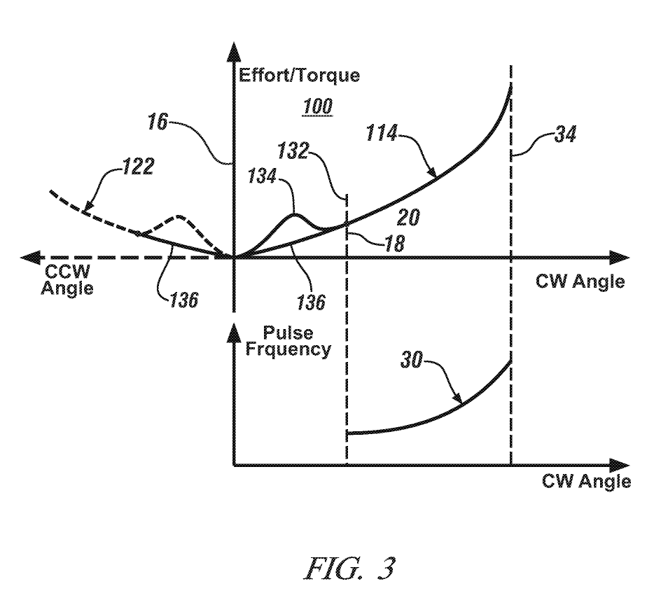

Referring to FIG. 3, another embodiment comprises a scrolling control system 100 that is similar in structure and function to that of the scrolling control system 10 of FIG. 2. Therefore, reference to like features will be made with similar reference numerals that represent features present in scrolling control system 10.

The rotational control 12 is configured to facilitate an angle-torque relationship 114 that depicts the relationship between the rotational position of the rotational control 12 and a torque associated with movement away from the first position 16. As discussed above, the first position 16 corresponds to an increase in the rate of scrolling through the plurality of user selections. As the rotational control 12 is rotated away from the first position 16, an angle is defined between the first position 16 and the rotated position. The angle determines the scrolling rate and the frequency of vibrational pulses felt by the user. It can be seen from the angle-torque relationship 114 that the torque, and therefore the scrolling frequency, may increase exponentially based on rotation of the rotational control 12. It is to be appreciated that the illustrated angle-torque relationship 114 is merely exemplary, and it is conceivable that numerous distinct relationship profiles may be employed by simply modifying the tactile feedback mechanism, which comprises, at least in part, at least one actuator that responds to an electrical stimulus. Only a partial angle-torque relationship 122 for rotation of the rotational control 12 in the counterclockwise direction is illustrated, however, it is to be understood that the scrolling control system 10 may employ a mirror-image function of the clockwise rotational function, as described above.

The angle-torque relationship 114 illustrated is distinct from angle-torque relationship 14, based on the initial motion in either direction from the first position 16. Similar to angle-torque relationship 14, the scrolling control system 100 may delay the initiation of vibrational pulses until the rotational control 12 has reached a predetermined rotational angle 132, relative to the first position 16. Prior to rotation to the predetermined rotational angle 132, a user may manually scroll one step at a time through the plurality of user selections. It is during this stage of operation that the user only feels the self-centering torque that is present at the first position 16. Specifically, the self-centering torque increases until an angle of rotation reflected at a peak 134 of the angle-torque relationship 114 within the region defined by the first position 16 and the predetermined rotational angle 132. The illustrated dropoff results in a click of the rotational control 12, providing a “ratchet-like” effect. This allows the user the ability to scroll one unit up or down in a traditional manner. The ratchet-like effect is generally illustrated with portion 136, where the rotational control 12 returns to the first position 16. In the event the user desires to more rapidly scroll through the plurality of user selections, the rotational control 12 may be rotated past the predetermined rotational angle 132, at which point a faster rate of scrolling is achieved. Similar to angle-torque relationship 14, the pulse frequencies 30 become more rapid as the rotational control 12 is rotated further away from the first position 16. Additionally, the scrolling control system 100 also includes the maximum angle 34 that the rotational control 12 may rotate to. Such a maximum angle 34 is typically set to a comfortable location for a user's wrist. It is at the maximum angle 34 that the user is able to achieve a maximum scrolling function through the plurality of user selections.

Advantageously, the scrolling control system 10, 100 provides the user the capability to scroll through the plurality of user selections at desired speeds, while expending less effort than that required in systems that necessitate continuous motion. Additionally, the scrolling control system 10, 100 utilizes haptic technology to provide the user with tactile feedback that corresponds to various scrolling frequencies.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed:

1. A scrolling control system having tactile feedback comprising:
a rotational control for scrolling through a plurality of user selections;
a first position of the rotational control, wherein rotation away from the first position scrolls through the plurality of user selections; and
a pulsating system for providing tactile feedback to a user, wherein the pulsating system distributes pulses at a plurality of frequencies that correspond to a plurality of rotational control positions.

2. The scrolling control system of claim 1, wherein the scrolling control system is disposed in a vehicle.

3. The scrolling control system of claim 2, further comprising a user system including the plurality of user selections.

4. The scrolling control system of claim 3, wherein the user system is an audio system.

5. The scrolling control system of claim 3, wherein the user system is a navigational system.

6. The scrolling control system of claim 1, wherein rotation of the rotational control in a clockwise direction away from the first position initiates the pulsating system.

7. The scrolling control system of claim 6, wherein a rotational position of the rotational control defines an angle between the rotational position and the first position.

8. The scrolling control system of claim 7, wherein the angle determines a pulse frequency of the pulsating system, wherein the pulse frequency increases as the angle increases.

9. The scrolling control system of claim 6, wherein rotation of the rotational control in a counterclockwise direction away from the first position initiates the pulsating system.

10. A scrolling control system having tactile feedback comprising:
a rotational control for scrolling through a plurality of user selections;
a first position of the rotational control, wherein rotation away from the first position scrolls through the plurality of user selections;
a second position of the rotational control that is disposed at a first angle from the first position, wherein a first scrolling frequency occurs when the rotational control is disposed at the second position;
a third position of the rotational control that is disposed at a second angle that is greater than the first angle, wherein a second scrolling frequency occurs when the rotational control is disposed at the third position, and wherein the second scrolling frequency is greater than the first scrolling frequency; and
a pulsating system for providing tactile feedback to a user.

11. The scrolling control system of claim 10, wherein the scrolling control system is disposed in a vehicle.

12. The scrolling control system of claim 11, further comprising a user system including the plurality of user selections.

13. The scrolling control system of claim 12, wherein the user system is an audio system.

14. The scrolling control system of claim 12, wherein the user system is a navigational system.

15. A vehicle having a tactile feedback control system comprising:
a user system including a rotational control for scrolling through a plurality of user selections;
a first position of the rotational control, wherein rotation away from the first position scrolls through the plurality of user selections; and
a tactile response mechanism for providing a plurality of tactile feedback sensations corresponding to a plurality of rotational control positions.

16. The vehicle of claim 15, wherein the user system is an audio system.

17. The vehicle of claim 15, wherein the user system is a navigational system.

18. The vehicle of claim 15, wherein a rotational position of the rotational control defines an angle between the rotational position and the first position.

19. The vehicle of claim 18, wherein the angle determines a feedback sensation frequency of the tactile response mechanism, wherein the feedback sensation frequency increases as the angle increases.

20. The vehicle of claim 18, wherein the tactile feedback sensations increase exponentially in proportion to the angle.
